(19) United States
(12) Patent Application Publication
(10) Pub. No.: US 2007/0213474 A1
(43) Pub. Date: Sep. 13, 2007

(54) POLYSILOXANE GRAFT POLYMER

(75) Inventors: Jochen Ebenhoch, Seoul (KR); Andreas Bacher, Burghausen (DE); Helmut Oswaldbauer, Stubenberg (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/568,636

(22) PCT Filed: Apr. 28, 2005
(86) PCT No.: PCT/EP05/04599

§ 371 Date: Nov. 3, 2006

(30) Foreign Application Priority Data
May 6, 2004 (DE) 10 2004 022 406.4

(51) Int. Cl. C08F 285/00; C08F 283/12

(52) U.S. Cl. 525/479

(57) ABSTRACT

Particulate additives which may be added to thermoset or thermoplastic polymers while maintaining transparency comprise core/shell polysiloxane graft polymers having a silicone core, optionally an inner addition polymer core within the silicone core, and an addition polymer shell. The silicone core is derived from at least one monomer having conjugated electron pairs.

The invention relates to a polysiloxane graft polymer for modification of thermoplastics or of thermosets, in particular of molding compositions based on (meth)acrylate polymers, to a process for preparation of these, and also to the use as modifier, in particular impact modifier.

In order to improve the impact resistances of molding compositions which are prepared from hard thermoplastic polymers, such as methacrylic ester polymers or acrylic ester polymers, rubbery materials are admixed with the hard thermoplastics. These materials are mostly graft copolymers having an elastomeric silicone core or elastomeric organopolymer core, and a polymer shell grafted onto this core.

U.S. Pat. No. 4,918,132 describes impact modifiers for polyester resins, composed of a core-shell polymer having a core composed of a mixture of polysiloxane rubber and (meth)acrylate rubber and having a polymer shell. WO-A 02/36682 and WO-A 02/36683 describe PMMA molding compositions with improved low-temperature impact resistance and with an impact modifier mixture composed of silicone elastomer with PMMA shell and acrylate rubber. EP-A 537014 describes impact-modified polycarbonates, where the modifier used comprises particles having polysiloxane/organopolymer core and organopolymer shell. EP-A 258746 discloses silicone rubber graft polymers with notched impact resistance having silicone core and organopolymer shell. EP-A 791617 discloses core-shell impact modifiers composed of a polyacrylate core, of a first silicone shell, and of another polyacrylate shell. EP-A 492376 discloses elastomeric graft copolymers having core-shell structure, these being composed of a polysiloxane core, of an organopolymer shell and, if appropriate, of a polydialkylsiloxane intermediate layer. WO-A 03/066695 describes silicone rubber polymers with core-shell structure which are obtained via a specific process for grafting-on the organic shell. DE-A 10204890 relates to molding compositions composed of poly(meth)acrylate and silicone rubber graft polymer where the silicone core prior to the grafting process contains vinyl radicals, and a mixture composed of acrylate and methacrylate is grafted on.

A disadvantage with the impact modifiers known from the prior art and based on silicone elastomers is the cloudiness of the molding compositions modified therewith, due to the different refractive indices of thermoplastic and impact modifier. EP-A 62223 discloses transparent, impact-resistant molding compositions in which the hard component based on a terpolymer composed of styrene, acrylonitrile, and methyl methacrylate has been modified with a styrene-butadiene rubber which has been grafted with a shell with the same constitution as the hard component. The identical constitution of rubber shell and hard component brings about equalization of the refractive indices and contributes to retention of transparency.

It was therefore an object to develop a modifier which is based on a polysiloxane elastomer and whose refractive index approximates to that of the thermosets or thermoplastics to be modified, in particular to (meth)acrylate polymers.

Surprisingly, it has been found that this can be achieved via polymerization incorporating units having conjugated electron pairs into the silicone core.

The invention provides polysiloxane graft polymers, composed of a silicone core a) which has one or more surrounding polymer shells b) and which, if appropriate, also comprises one or more inner cores c) surrounded by the silicone fraction a), where the silicone fraction a)

a1) contains one or more structural units from the group encompassing the general formula [R¹₂SiO_{2/2}], and

a2) contains one or more structural units from the group encompassing the general formulae [R¹₁₋ₓR²ₓ₊₁SiOR¹_{2/2}], [R²SiO_{3/2}] and [R¹_{2-y}R²_{y+1}SiO_{1/2}], and

a3) contains one or more structural units having ethylenically unsaturated groups or mercaptoalkyl groups of the general formula [R³ₐR⁴_{b}SiO_{z/2}] and, if appropriate,

a4) contains one or more tri- or tetrafunctional structural units of the general formulae [R¹SiO_{3/2}] and [SiO_{4/2}], and

the polymer shell b) is a polymer of one or more monomers from the group encompassing ethylenically unsaturated monomers, and

the inner core c) is a polymer of one or more monomers from the group encompassing ethylenically unsaturated monomers,

where R¹ is identical or different, unsubstituted or substituted, alkyl radicals having from 1 to 18 carbon atoms, R² is identical or different radicals having conjugated electron pairs, R³ is identical or different radicals of the formulae —(CH₂)ₘ—CR⁵═CH₂, —(CH₂)ₘ₊₁—O(C═O)—CR⁵═CH₂, and —(CH₂)ₘ₊₁—SH, R⁴ is as defined for R¹ or R², R⁵ is H or CH₃, and a=from 0 to (4-z), b=from 0 to (3-z), m=from 0 to 6, x=0 or 1, and y=from 0 to 2, and z=from 1 to 3.

The radicals R¹ are preferably monovalent alkyl radicals having from 1 to 18 carbon atoms, which may, if appropriate, have one or more substituents which are halogen, cyano, amino, or hydroxy radicals, and which, if appropriate, can have interruption via one or more heteroatoms from the group encompassing nitrogen, oxygen, sulfur. Examples are the methyl, ethyl, n-propyl, isopropyl, n-butyl, sec-butyl, amyl, hexyl radical. Examples of substituted hydrocarbon radicals are haloalkyl radicals, such as the chloromethyl, 3-chloropropyl, 3-bromopropyl, 3,3,3-trifluoropropyl, and 5,5,5,4,4,3,3-heptafluoropentyl radical; cyanoalkyl radicals, such as the 2-cyanoethyl and 3-cyanopropyl radical; aminoalkyl radicals, such as the 3-aminopropyl radical; hydroxyalkyl radicals, such as the hydroxypropyl radical. Particular preference is given to monovalent, C₁-C₄-alkyl radicals, such as the methyl, ethyl, propyl radical; the methyl radical is most preferred.

By way of example, the structural units a1 can be obtained using dialkyldialkoxysilanes, such as dimethyldimethoxysilane or dimethyldiethoxysilane. Other suitable compounds are oligomers of the formula (R¹₂SiO)ₙ, where n=from 3 to 8, e.g. octamethylcyclotetrasiloxane or hexamethylcyclotrisiloxane.

The radicals R² having conjugated electron pairs are preferably radicals having conjugated double bonds, radicals having conjugated carbonyl groups, radicals having halogen, in particular, iodine, bromine, and chlorine, sulfur-substituted radicals, substituted vinyl radicals, aryl radicals. Preference is given to the phenyl radical or halogen-, cyano-, amino-, or hydroxy-substituted phenyl radicals, or arylalkyl radicals or alkylaryl radicals in each case having the C₁-C₃-alkyl radical. The phenyl radical is most preferred.

Suitable silanes for incorporation of the structural unit a2 are appropriately substituted alkylsilanes, alkylalkoxysilanes, or else alkoxysilanes, in each case preferably having the C₁-C₃-alkyl or -alkoxy radical. Preference is given to trialkoxysilanes, such as phenyltrimethoxysilane and phenyltriethoxysilane, and also to dialkoxysilanes, such as methylphenyldiethoxysilane and diphenyldiethoxysilane.

Preferred radicals R³ in the structural units a3 are those having α-methacryloxymethyl, α-acryloxymethyl, γ-acryloxypropyl, γ-methacryloxypropyl, vinyl, allyl, propenyl, hexenyl, and 3-mercaptomethyl, 3-mercaptoethyl, or else 3-mercaptopropyl radicals.

Suitable silanes for incorporation of the structural unit a3 are γ-acryl- and γ-methacryloxyalkyltri(alkoxy)silanes, α-methacryloxyalkyltri(alkoxy)silanes, γ-methacryloxyalkyldi(alkoxy)silanes, vinylalkyl(dialkoxy)silanes, and vinyltri(alkoxy)silanes, examples of alkoxy groups that can be present being methoxy, ethoxy, methoxyethylene, ethoxyethylene, methoxypropylene glycol ether, and ethoxypropylene glycol ether radicals. Examples of preferred silane monomers are 3-methacryloxypropyltrimethoxysilane, 3-methacryloxypropylmethyldimethoxysilane, vinyltrimethoxysilane, vinyltriethoxysilane, vinyltriacetoxysilane, allyltrimethoxysilane, hexenyltrimethoxysilane. Preferred silanes containing mercaptoalkylsilane groups are mercaptoethyl- and mercaptopropylsilanes, such as 3-mercaptopropyltriethoxysilane, 3-mercaptopropyltrimethoxysilane, 2-mercaptoethyltrimethoxysilane, 2-mercaptoethyltriethoxysilane, mercaptomethyltrimethoxysilane, mercaptomethyltriethoxysilane, and 3-mercaptopropylmethyldimethoxysilane.

A preferred structural unit a4) is those having a C₁-C₆-alkyl radical, and most preference is given to the methyl radical and also to the structural unit [SiO_{4/2}]. Suitable silane monomers for introduction of the structural unit [SiO_{4/2}] are tetraalkoxysilanes, such as tetramethoxysilane and tetraethoxysilane. Suitable silane monomers for introduction of the structural unit [R¹SiO_{3/2}] are alkyltrialkoxysilanes having a C₁-C₃-alkyl radical and C₁-C₃-alkoxy radical, preferably the methyl and methoxy radical, e.g. methyltrimethoxysilane.

Suitable polymers for construction of the polymer shell b), and also, if appropriate, of the inner core c), are those of one or more monomers from the group encompassing vinyl esters, of unbranched or branched alkyl carboxylic acids having from 1 to 15 carbon atoms, methacrylates and acrylates of alcohols having from 1 to 15 carbon atoms, vinylaromatics, olefins, dienes, N-containing monomers and vinyl halides. Examples of these are vinyl acetate, vinyl propionate, methyl(meth)acrylate, ethyl(meth)acrylate, isopropyl(meth)acrylate, butyl(meth)acrylate, benzyl acrylate, styrene, p-methylstyrene, α-methylstyrene, tert-butylstyrene, ethylene, butadiene, isoprene, chloroprene, acrylonitrile, methacrylonitrile, maleimide, N-substituted maleimide, vinyl chloride. Other suitable monomer units are those having epoxy, hydroxy, carboxy, or else amino groups; by way of example, glycidyl acrylate, glycidyl methacrylate, allyl glycidyl ether, vinyl glycidyl ether, hydroxyethyl(meth)acrylate, aminoalkyl(meth)acrylates. Particular preference is given to styrene, acrylates and methacrylates of aliphatic alcohols having from 1 to 4 carbon atoms. Methyl methacrylate, or methyl methacrylate in combination with styrene, is most preferred, in each case if appropriate in combination with one or more acrylates.

The polymers for the polymer shell b), and also, if appropriate, for the inner core c), can, if appropriate, be composed entirely or to some extent, based on the total weight of the polymer, of crosslinking monomer units. Further examples here are crosslinking ethylenically polyunsaturated comonomers, such as divinyl adipate, divinylbenzene, diallyl maleate, allyl methacrylate, butanediol diacrylate, diethylene glycol di(meth)acrylate, or triallyl cyanurate. Preference is given to the crosslinking, ethylenically polyunsaturated comonomers, in particular diethylene glycol di(meth)acrylate.

Uncrosslinked or partially crosslinked polymers are most preferred for the polymer shell b), and also, if appropriate, for the inner core c).

The graft polymers preferably comprise from 0.05 to 95% by weight of the silicone fraction a), from 5 to 95% by weight of the polymer shell(s) b), and also, if appropriate, from 0 to 80% by weight of the inner core(s) c), based in each case on the total weight of the graft polymer. If the graft polymers comprise one or more inner cores c), their fraction amounts to from 0.05 to 95% by weight. The meaning of inner core here is that the polymer shell b) surrounds a core which is composed of a polymer fraction c), encapsulated by a silicone fraction a). The graft polymers are preferably composed of from 30 to 95% by weight of silicone fraction a) as core and from 5 to 70% by weight of polymer shell b).

The silicone fraction a) preferably contains from 0.05 to 85% by weight of structural units a1), from 5 to 99% by weight of structural units a2), from 0.05 to 20% by weight of structural units a3), and from 0 to 30% by weight of structural units a4), based in each case on the total weight of the silicone fraction a), where the fractions in % by weight always give a total of 100% by weight.

The average (weight-average) particle size of the graft polymers is from 5 nm to 100 μm, preferably from 5 nm to 5 μm, most preferably from 10 nm to 400 nm, measured using a Coulter LS.

The graft polymers can be prepared by means of emulsion polymerization in an aqueous medium or by means of solution polymerization in organic solvents. Aqueous emulsion polymerization is preferred. This can, if suitable starting substances are selected, which, if appropriate, can also have a relatively high level of condensation, take the form of an addition polymerization (hydrosilylation) in the presence of noble metal catalysts, or can take the form of a condensation polymerization in the presence of tin catalysts, another alternative being silane hydrolysis and condensation.

Silane hydrolysis and condensation is particularly preferred. For this, the emulsion polymerization is carried out at a temperature of from 30° C. to 100° C., preferably from 60° C. to 95° C. for preparation of the silicone fraction a), either as graft base or in grafting onto an inner core c). The pH of the mixture is preferably set at a value of from 1 to 4. The polymerization can be carried out either by a continuous procedure or by a batch procedure. The batch procedure is preferred, but it is particularly preferable here that all or some of the monomers for the silicone fraction a) are used as feed. In the case of batchwise preparation of the graft base, it is advantageous to continue stirring for from 0.5 to 6 hours after the end of feed of the components of the silicone fraction a). For further improvement of the stability of the polysiloxane emulsion, it is preferable that the alcohol liberated during the hydrolysis reaction is removed via distillation. The amount of emulsifier to be used is from 0.5 to 20.0% by weight, preferably from 1.0 to 3.0% by weight, based in each case on the amount of organosilicon compounds used.

Suitable emulsifiers are carboxylic acids having from 9 to 20 carbon atoms, aliphatically substituted benzenesulfonic acids having at least 6 carbon atoms in the aliphatic substituents, aliphatically substituted naphthalenesulfonic acids having at least 4 carbon atoms in the aliphatic substituents, aliphatic sulfonic acids having at least 6 carbon atoms in the aliphatic radicals, silylalkylsulfonic acids having at least 6 carbon atoms in the alkyl substituents, aliphatically substituted diphenyl ether sulfonic acids having at least 6 carbon atoms in the aliphatic radicals, alkyl hydrogensulfates having at least 6 carbon atoms in the alkyl radicals, quaternary ammonium halides or quaternary ammonium hydroxides. All of the acids mentioned can be used as they stand or, if appropriate, in a mixture with their salts. If anionic emulsifiers are used, it is advantageous to use those whose aliphatic substituents contain at least 8 carbon atoms. Aliphatically substituted benzenesulfonic acids are preferred as anionic emulsifiers. If cationic emulsifiers are utilized, it is advantageous to use halides.

For preparation of the organic polymer shell b) and, respectively, of the organic inner core c), a (graft) polymerization reaction is carried out by means of emulsion polymerization in the presence of water-soluble or monomer-soluble free-radical initiators. Suitable free-radical initiators are water-soluble peroxo compounds, organic peroxides, hydroperoxides, or azo compounds. It is also possible to operate with initiator combinations composed of oxidant and reducing agent. The preferred amount used here of oxidation component and reduction component is in each case from 0.01 to 2.0% by weight, based on the amount of monomer, and Fe²⁺ salts are added here if appropriate. By way of example, tert-butyl hydroperoxide and ascorbic acid are particularly preferably used for redox catalysis here. The reaction temperatures depend on the nature of the initiator used and are from 15° C. to 90° C., preferably from 30° C. to 85° C.

If a graft polymer is prepared using one or more inner cores c), a first step comprises free-radical polymerization of the appropriate ethylenically unsaturated monomers. The components of the silicone fraction a) are then added to the polymer latex thus obtained, and are grafted onto the inner core c) under the abovementioned conditions. When preparing an inner core, it can be advantageous, during the polymerization, to add specifically functionalized monomers which bring about chemical coupling to the subsequent silicone shell, and/or suppress to some extent or entirely any fresh nucleation of the silicone components. In the grafting reaction, the components, or individual components, of the silicone fraction a) can be used to some extent as an initial charge and to some extent as a subsequent feed, or the feed process can be used without any initial charge. In the final step, free-radical-initiated polymerization is used for grafting the monomers destined to form the polymer shell b) onto the silicone-containing latex particles thus obtained. Here again, in the grafting reaction, the monomers, or individual monomers, of the polymer fraction b) can be used to some extent as an initial charge and to some extent as a subsequent feed, or the feed process can be used without any initial charge.

For preparation of graft polymers composed of a silicone core a) and of a polymer shell b), the silicone fraction a) is first polymerized in the emulsion polymerization process described above, in the presence of the emulsifiers mentioned, and preferably with feed of the monomer components a). The monomers destined to form the polymer shell b) are then free-radical-polymerized under the abovementioned conditions. In the grafting reaction, the monomers, or individual monomers, of the polymer fraction b) can be used to some extent as an initial charge and to some extent as a subsequent feed, or the feed process can be used without any initial charge.

The particle size can be varied in a known manner via the selection of the reaction conditions and of the amount of emulsifiers. Use of an initial charge of a seed latex is another suitable method of varying the particle size. Known processes can be used to isolate the inventive graft copolymers from the emulsion, examples being coagulation of the latices by means of freeze coagulation, or salt addition, or addition of polar, at least to some extent water-miscible, solvents, or spray drying.

The inventive graft copolymers are especially suitable for modification of thermoplastics or of thermosets, in particular transparent thermoplastics. Examples of these are (meth)acrylate polymers, such as polymethyl methacrylate, polystyrene, polyolefins, polyamides, polyvinyl chloride, polyoxymethylene, polycarbonates, epoxy resins, unsaturated polyester resins. The modifiers bring about, inter alia, improved mechanical properties, such as weathering resistance and aging resistance, resistance to temperature variation, in particular resistance to high temperature, impact resistance, and fracture resistance, in particular low-temperature impact resistance together with high transparency. The modifiers moreover improve the fire properties of the polymers, by markedly improving their flame retardancy. Another factor that should be mentioned is improved acceptance of color pigments and of other additives, for example for flame retardancy.

### INVENTIVE EXAMPLE 1

1660 g of water and 9.62 g of dodecylbenzenesulfonic acid were heated to 90° C. Within a period of 4 hours, a mixture composed of 460.3 g of octamethylcyclotetrasiloxane, 250 g of phenyltriethoxysilane, 5.2 g of methyltrimethoxysilane and 32.4 g of methacryloylpropyltrimethoxysilane was used as feed, with stirring.

Once the feed had ended, stirring of the mixture was continued at 90° C. for a further 4 hours and it was then neutralized. Distillation to remove a distillate gave a silicone dispersion whose solids content was 22.5% and whose particle size was 87 nm (weight-average Dw; Coulter LS 230).

890 g of the dispersion were diluted with water to 22% solids content, and used as initial charge in a reactor and heated to 45° C., with stirring.

At 45° C., 100 g of methyl methacrylate (MMA) were used as feed within a period of 30 minutes. Once all of the MMA had been added, 0.6 ml of 1% strength aqueous iron ammonium sulfate solution and 0.6 ml of a 2% strength aqueous TrilonB solution were first added. 0.77 g of ascorbic acid in 13.7 g of water and 0.98 g of tert-butyl hydroperoxide (TBHP) (40% strength in water) in 6.4 g of water were then introduced over a period of 1.5 h into the mixture, with stirring. Once feed of the initiators had ended, the mixture was stirred at 45° C. for a further 60 minutes. Polymerization was continued to complete conversion using ascorbic acid and tert-butyl hydroperoxide. This gave a dispersion whose solids content SC was 28.7% and whose particle size was 95 nm (Dw; Coulter LS 230).

### INVENTIVE EXAMPLE 2

The preparation process was carried out by analogy with inventive example 1, but no methyltrimethoxysilane feed was used during preparation of the core.

This gave a silicone dispersion whose solids content was 23.8% and whose particle size was 85 nm (Dw; Coulter LS 230). Once MMA had been grafted on, this gave a dispersion whose solids content was 29.0% and whose particle size was 92 nm (Dw; Coulter LS 230).

### INVENTIVE EXAMPLE 3

The preparation process was carried out by analogy with inventive example 2, but instead of 250 g of phenyltriethoxysilane, 250 g of methylphenyldiethoxysilane were used as feed during preparation of the core.

This gave a silicone dispersion whose solids content was 21.3% and whose particle size was 93 nm (Dw; Coulter LS 230). Once MMA had been grafted on, this gave a dispersion whose solids content was 29.1% and whose particle size was 98 nm (Dw; Coulter LS 230).

### INVENTIVE EXAMPLE 4

The preparation process was carried out by analogy with inventive example 2, but instead of 250 g of phenyltriethoxysilane, 250 g of diphenyldiethoxysilane were used as feed during preparation of the core. This gave a silicone dispersion whose solids content was 20.3% and whose particle size was 90 nm (Dw; Coulter LS 230). Once MMA had been grafted on, this gave a dispersion whose solids content was 28.6% and whose particle size was 94 nm (Dw; Coulter LS 230).

### INVENTIVE EXAMPLE 5

The preparation process was carried out by analogy with inventive example 1, but 3.75 g of diethylene glycol dimethacrylate were additionally mixed with the MMA and used jointly as feed during the grafting reaction. This gave a dispersion whose solids content SC was 28.7% and whose particle size was 92 nm (Dw; Coulter LS 230).

### INVENTIVE EXAMPLE 6

The preparation process was carried out by analogy with inventive example 1, but 90 g of MMA and 10 g of styrene were used for the grafting reaction. This gave a dispersion whose solids content SC was 27.8% and whose particle size was 95 nm (Dw; Coulter LS 230).

### INVENTIVE EXAMPLE 7

1660 g of water and 9.62 g of dodecylbenzenesulfonic acid were heated to 90° C. Within a period of 4 hours, a mixture composed of 460.3 g of octamethylcyclotetrasiloxane, 250 g of phenyltriethoxysilane, 5.2 g of methyltrimethoxysilane and 19.3 g of vinyltrimethoxysilane was used as feed, with stirring. Once the feed had ended, stirring of the mixture was continued at 90° C. for a further 4 hours and it was then neutralized. Distillation to remove a distillate gave a silicone dispersion whose solids content was 21.9% and whose particle size was 92 nm (weight-average Dw; Coulter LS 230).

The dispersion was then diluted to 20% by weight solids content and heated to 55° C. 0.67 g of concentrated acetic acid and 0.00075 g of ferrous sulfate were admixed with 1000 g of the dispersion. A solution of 0.59 g of sodium hydroxymethylsulfinate in 8.6 g of water was then used as feed to the dispersion over a period of 20 minutes. At the same time, feed of 0.6 g of tert-butyl hydroperoxide (40% strength in water) in 7.9 g of water was begun. The mixture was used as feed over a period of 180 minutes. At the same time, 150.6 g of MMA were used as feed over a period of 180 minutes. Once the feed had ended, polymerization of the dispersion was completed during a further 30 minutes at 55° C. After cooling to 30° C., the dispersion was filtered through a 250 μm sieve.

This gave a dispersion whose solids content SC was 30.1% and whose particle size was 101 nm (Dw; Coulter LS 230).

### INVENTIVE EXAMPLE 8

820 g of water and 1.71 g of dodecylbenzenesulfonic acid, 148.3 g of methyl methacrylate and 0.7 ml of 1% strength aqueous iron ammonium sulfate solution were heated to 70° C.

The reaction was initiated by using, as feed, 24 ml/h of a 1.5% strength aqueous tert-butyl hydroperoxide solution and 13.5 ml/h of a 15% strength aqueous ascorbic acid solution. Once the solids content of the mixture had reached >20%, a pre-emulsion composed of 425.7 g of water, 1.71 g of dodecylbenzenesulfonic acid, 875 g of methyl methacrylate, 113 g of hydroxyethyl methacrylate and 1.14 g of diethylene glycol dimethacrylate was used as feed over a period of 4 h. Feed of the initiator was ended 30 minutes after the end of the feed of pre-emulsion. After cooling, polymerization was continued using tert-butyl hydroperoxide and ascorbic acid.

This gave a dispersion whose solids content SC was 44.0% and whose particle size was 133 nm (Dw; Coulter LS 230).

311.4 g of this dispersion were diluted with 1410 g of water and heated to 90° C. A mixture composed of 155 g of octamethylcyclotetrasiloxane, 96 g of phenyltriethoxysilane, 14.4 g of methyltrimethoxysilane and 10.3 g of vinyltrimethoxysilane was used as feed, with stirring. 10 minutes after the start of the monomer feed, a mixture composed of 6.21 g of dodecylbenzenesulfonic acid and 97 g of water was used as feed over a period of 1.5 h. Once the monomer feed had ended, stirring of the mixture was continued at 90° C. for a further 4 hours, and it was cooled and neutralized. A silicone dispersion whose solids content was 20.7% and whose particle size was 141 nm was then obtained by a distillation to remove water (weight-average Dw; Coulter LS 230).

902 g of the dispersion were heated to 45° C. in a reactor, with stirring.

At 45° C., 93.5 g of methyl methacrylate. (MMA) were used as feed within a period of 30 minutes. Once all of the MMA had been added, 0.6 ml of 1% strength aqueous iron ammonium sulfate solution and 0.6 ml of a 2% strength aqueous TrilonB solution were first added. 0.72 g of ascorbic acid in 13.7 g of water and 0.93 g of tert-butyl hydroperoxide (TBHP) (40% strength in water) in 6.4 g of water were then introduced over a period of 1.5 h into the mixture, with stirring. Once feed of the initiators had ended, the mixture was stirred at 45° C. for a further 60 minutes. Polymerization was continued to complete conversion using ascorbic acid and tert-butyl hydroperoxide. This gave a dispersion whose solids content SC was 29.2% and whose particle size was 144 nm (Dw; Coulter LS 230).

### COMPARATIVE EXAMPLE 1

The preparation process was carried out by analogy with inventive example 1, but no phenyltriethoxysilane, and 32 g of methyltrimethoxysilane, were used as feed during preparation of the core.

This gave a silicone dispersion whose solids content was 21.7% and whose particle size was 97 nm (Dw; Coulter LS 230). Grafting-on of MMA gave a dispersion whose solids content was 28.5% and whose particle size was 107 nm (Dw; Coulter LS 230).

### PERFORMANCE TEST

The resultant dispersions were extracted with ethyl acetate and dried in vacuo to give a powder. 18 g of the resultant powder were incorporated into 82 g of polymethyl methacrylate (PMMA 7N from Röhm) by means of a Collin laboratory roll mill and then pressed to give sheets of thickness 4 mm.

The impact resistance test used DIN 53453 test method ISO 179-1 and a 50×6×4 mm³ test specimen without notch.

Transparency was determined on the sheets of thickness 4 mm to DIN 6174.

The results are collated in the table below.

TABLE 1

| | Impact | Impact | |
|---|---|---|---|
| | resistance @ | resistance @ | Transparency |
| | −20° C. [kJ/m²] | −40° C. [kJ/m²] | [%] |
| Inv. ex. 1 | 17 | 15 | 81 |
| Inv. ex. 2 | 18 | 17 | 87 |
| Inv. ex. 3 | 16 | 16 | 86 |
| Inv. ex. 4 | 15 | 14 | 89 |
| Inv. ex. 5 | 19 | 15 | 82 |
| Inv. ex. 6 | 18 | 16 | 72 |
| Inv. ex. 7 | 20 | 17 | 78 |
| Inv. ex. 8 | 22 | 19 | 82 |
| Comp. ex. 1 | 18 | 17 | 58 |

1-10. (canceled)

11. A polysiloxane graft polymer, composed of a silicone core a) surrounded by at least one polymer shell b), said silicone core a) optionally surrounding one or more inner cores c):
wherein the silicone core a) comprises
a1) one or more [R¹₂SiO_{2/2}] structural units;
a2) one or more [R¹₁₋ₓR²ₓ₊₁SiO_{2/2}], [R²SiO_{3/2}], and [R¹_{2-y}R²_{y+1}SiO_{1/2}] structural units; and
a3) one or more ethylenically unsaturated or mercaptoalkyl-functional structural units of the formula [R³ₐR⁴_{b}SiO_{z/2}]; and
a4) one or more tri- or tetrafunctional structural units of the formulae [R¹SiO_{3/2}] and [SiO_{4/2}];
the polymer shell b) is a polymer of one or more ethylenically unsaturated monomers; and
the inner core c) is a polymer of one or more ethylenically unsaturated monomers, where each R¹ independently is an unsubstituted or substituted alkyl radical having from 1 to 18 carbon atoms; each R² independently is a radical having a conjugated electron pair; each R³ independently is a radical of the formulae —(CH₂)ₘ—CR⁵═CH₂, —(CH₂)ₘ₊₁—O(C═O)—CR⁵═CH₂, or —(CH₂)ₘ₊₁—SH; each R⁴ independently is as defined for R¹ or R²; each R⁵ independently is H or CH₃, and a is an integer from 0 to (4-z), b is an integer from 0 to (3-z), m is an integer from 0 to 6, x is 0 or 1, y is an integer from 0 to 2, and z is an integer from 1 to 3.

12. The polysiloxane graft polymer of claim 11, wherein the graft polymers comprise from 0.05 to 95% by weight of silicone core a) and from 5 to 95% by weight of polymer shell b).

13. The polysiloxane graft polymer of claim 11, wherein the silicone core a) contains from 0.05 to 85% by weight of structural units a1), from 5 to 99% by weight of structural units a2), from 0.05 to 20% by weight of structural units a3), and up to 30% by weight of structural units a4), based in each case on the total weight of the silicone core a).

14. The polysiloxane graft polymer of claim 11, wherein the structural units a1) comprise those in which R¹ is a monovalent C₁-C₄-alkyl radical.

15. The polysiloxane graft polymer of claim 11, wherein the structural units a2) present comprise those in which R² is a radical having conjugated double bonds, a radical having conjugated carbonyl radical, a halogen- or sulfur-substituted vinyl radical, or an aryl radical.

16. The polysiloxane graft polymer of claim 11, wherein the structural units a3) comprise those having one or more radicals R³ selected the group consisting of the α-methacryloxymethyl, α-acryloxymethyl, γ-acryloxypropyl, γ-methacryloxypropyl, vinyl, allyl, propenyl, hexenyl, 3-mercaptomethyl, 3-mercaptoethyl, and 3-mercaptopropyl radicals.

17. The polysiloxane graft polymer of claim 11, wherein the polymer shell b), and optionally the inner core c), are derived from at least one monomer selected from the group consisting of vinyl esters of unbranched or branched C₁₋₁₅ alkyl carboxylic acids, (meth)acrylates of C₁₋₁₅ alcohols, vinylaromatics, olefins, dienes, N-containing monomers, vinyl halides, epoxy-functional monomers, hydroxy-functional monomers, carboxy-fucntional monomers, and amino-functional monomers.

18. A process for preparation of the polysiloxane graft polymer of claim 11, comprising emulsion polymerizing:
optionally, unsaturated monomers to form an inner core;
monomers a) to form a silicone core; and
unsaturated monomers to form a shell outside of said silicone core.

19. A thermoset polymer or thermoplastic polymer composition containing at least one polysiloxane graft polymer of claim 11 dispersed in said polymer.

20. The polymer composition of claim 19, wherein polysiloxane graft polymer particles have a weight average particle size of from 5 nm to 400 nm.

21. The polymer composition of claim 19 which is transparent.
